(19) United States
(12) Patent Application Publication
(10) Pub. No.: US 2011/0089258 A1
(43) Pub. Date: Apr. 21, 2011

(54) Spray pattern modification with changes in sprayer design and methods

(76) Inventor: John Yenkai Pun, Coos Bay, OR (US)

(21) Appl. No.: 12/589,375

(22) Filed: Oct. 21, 2009

(51) Int. Cl. B05B 3/02

(52) U.S. Cl. 239/214.23

(57) ABSTRACT

A prior art sprayer includes structure modification and additions of components for controlling of spray pattern in shape and sizes to accommodate spray target profile. Changes also eliminate sparse spray droplet regions to give the target area more even spray droplet coverage. Modifications also intensify the spiral pattern of projected spray.

### BACKGROUND OF INVENTION

The present invention relates to change in design of an apparatus and methods of a previous U.S. Pat. No. 6,152,382 that is able to generate small diameter spray droplets by centrifugal method and be able to propel the spray in a single direction. As previously referred to in U.S. Pat. No. 6,152,382 other prior arts such as U.S. Pat. Nos. 4,609,145, 4,619,401, 4,795,095, and 5,037,029 use air to propel the spray droplets generated by rotating components, no control of spray pattern is offered. Improvement in the important area of controlling the spray cone shape and size, and filling in the center of spray pattern designs were not available until this application. While centrifugal spray droplet generation is apparently the only method for prior arts to generate uniform diameter droplets, no other prior art was found to propel the droplets in one direction toward a target. While prior art U.S. Pat. No. 6,152,382 with designs that propel the spray generated by centrifugal force in one direction, the size and shape of the spray pattern, important in spray applications, is fixed dependent on diameter of tube containing the spray generator assembly, air flow output of the high velocity axial fan, rotating speed and fixed sized rotating cone mounted on the atomizer motor. Diameter of the spray pattern is too large with some spray droplets not hitting the spraying target and drifting into the air. Center of spray of cylinder form has less spray droplets due to the centrifugal force of the cone being responsible for this thinning of spray droplets in the center of the spray pattern.

This invention is a modification of the designs of spray head in U.S. Pat. No. 6,152,382. It was found that a vortex pattern spray covers spray surfaces much more effectively. The vortex pattern is much more effective in agricultural and horticultural spraying by penetration of spray into the plants' interior bypassing the front blocking foliages. It gives a much more even spray coverage on flat surfaces. The other improvement is an adjustable spray cone pattern generator and modifier. This gives much better spray patterns according to need depending on type and shape of target than a fixed size and shape spray pattern can provide.

### SUMMARY

The present invention relates to modification of spray unit of prior art U.S. Pat. No. 6,152,382 and methods in operation. Modification of the shape of the atomizer (15) is essential to allow centrifugally generated droplets also traveling through the center of spray pattern to give more complete and even spray coverage. Instead of using rods to support the atomizer and blower motor assembly, curved plate shape supports are used to produce vortex air flow pattern and accentuate the curved air flow already existing in a smaller degree.

### BRIEF DESCRIPTIONS OF THE DRAWINGS

The accompanying drawings, which are incorporated and form a part of this specification, illustrate the embodiments of this invention and together with the descriptions, serve to explain the principles of the invention.

FIG. 1 is a full cross section elevation view of a spray unit (spray head) with a modified controlled atomizer of U.S. Pat. No. 6,152,382 in accordance with the present invention indicating the spatial relationships of added components such as curved supporting members of atomizer motor and turbine fan motor housing, primary cone for shaping and changing the spray pattern, and the secondary cone for using Venturi effect to gain extra airflow to help shape the spray pattern.

FIG. 2 is a perspective view of the sprayer unit with a section of the spinner motor and turbine fan motor housing as well as sections of primary and secondary cones removed to demonstrate sprayer construction and differences of air flow pattern (looseness and tightness of curvature) at various parts of sprayer.

FIG. 3 is a longitudinal cross section of sprayer showing mainly the atomizer that was the design in U.S. Pat. No. 6,152,382 and the fixed spray pattern it generates showing cylinder spray shape with sparse droplet distribution areas.

FIG. 4 is a longitudinal cross section of sprayer of this invention with primary and secondary cone fully extended from the housing resulting in a minimum sized spray droplet cone with uniform droplet distribution.

FIG. 5 is a longitudinal cross section of sprayer of this invention with primary and secondary cone maximally contracted from the housing resulting in a large spray droplet cone with uniform droplet distribution.

FIG. 6 is a longitudinal cross section of sprayer of this invention showing relative positions of primary and secondary cone position with the spinning droplet generator accompanied by illustrations of airflow pattern to projects a large spray cone pattern.

FIG. 7 is a longitudinal cross section of sprayer of this invention showing relative positions of primary and secondary cone position with spinning droplet generator accompanied by illustrations of airflow patterns to project small spray cone pattern.

### REFERENCE NUMERALS IN DRAWINGS

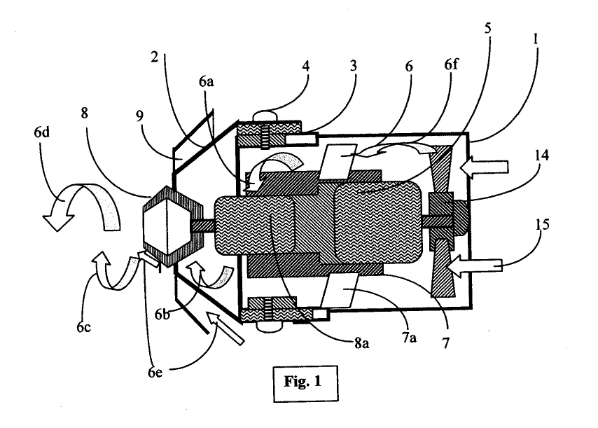

1. Main sprayer housing
2. Cone attachment with slots 180° apart with setscrew slots for mounting on FIG. 1, 1
3. Cemented on plastic piece with screw hole threads for setscrew
4. Setscrew
5. Turbine fan motor
6. Airflow direction with shallow curve pattern generated by turbine blades
6a. Airflow with tighter pattern of spirals generated by curve blades holding spinner and turbine motors to spray head housing
6b. Tight spiral airflow pattern in generating spray droplets produced by cone FIG. 1, 2; 2
6c. Progressively larger spiral air and spray pattern after existing spray head
6d. Larger spiral air and spray pattern
6e. Venturi generated air flow with cone FIG. 1, 9
7. Spinner(8a), turbine motors (5), and curved holders connected to sprayer housing
7a. Curved support between motor holder and sprayer
8. Spinning droplet generator
9. Secondary cone for generating air flow by Venturi effect
10. Sparse spray area
11. Dense spray area
12. Fluid input tube
13. Fixed spray pattern of U.S. Pat. No. 6,152,382
13a. Maximum size spray cone pattern with adjustable primary cone FIG. 1, 5, 6; 2
13b. Minimum size spray cone pattern with adjustable primary cone FIG. 4, 7; 2
14. Turbine blades assembly
15. Sprayer air intake
16. Spray and airflow pattern of maximum size spray cone
17. Airflow spiraling around the spinning droplet generator and exiting sprayer

### DETAILED DESCRIPTION OF THE PREFERRED EMBODIMENTS

Reference will now be made to the preferred embodiments of the invention, examples of which are illustrated in the accompanying drawings. While the invention will be described in conjunction with the preferred embodiments, it will be understood that they are not intended to limit this invention to those embodiments. On the contrary, the invention is intended to cover alternatives, modifications and equivalents, which may be included in the spirit and scope of the invention as defined by the application claims.

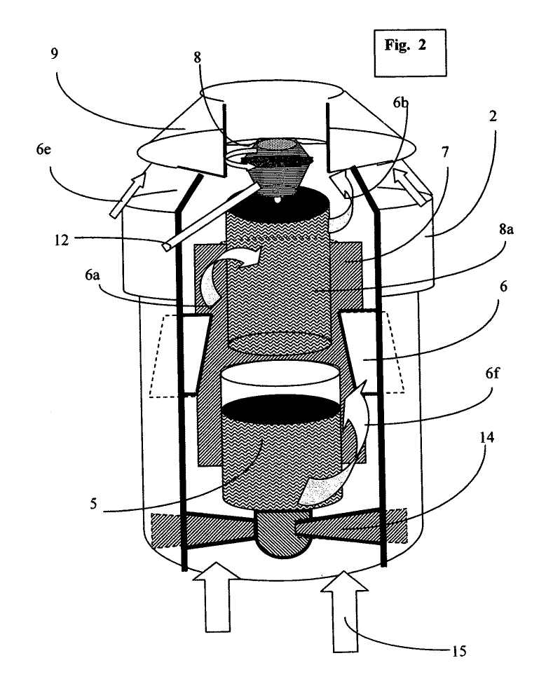

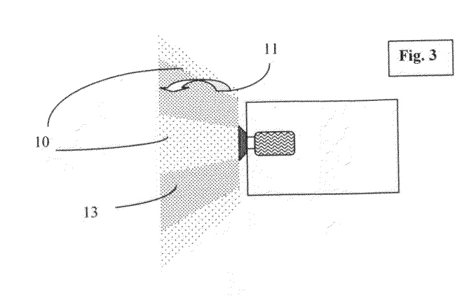

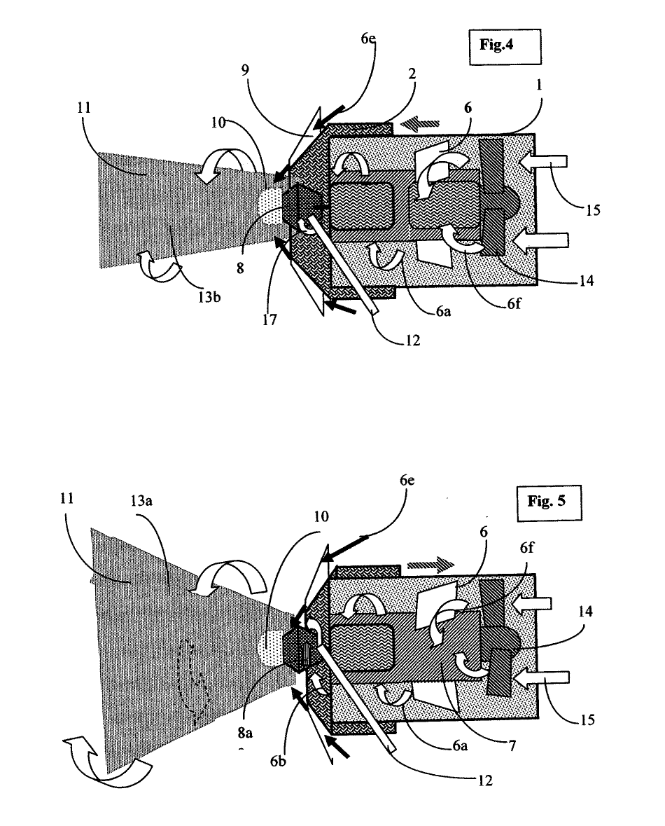

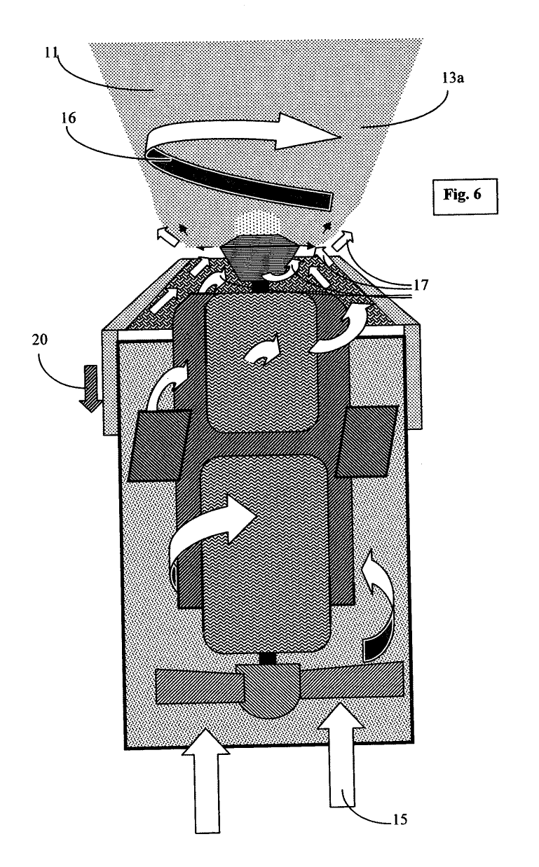

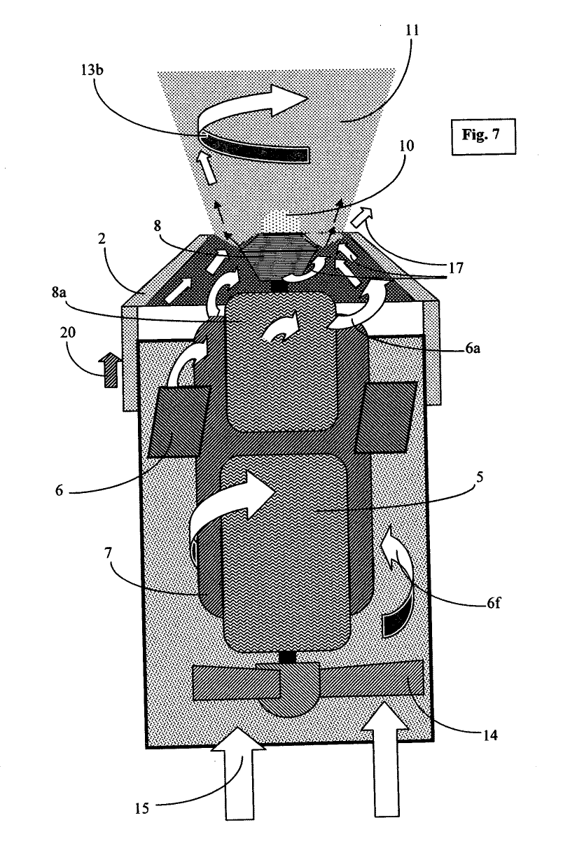

As described above, the present invention provides an apparatus and methods for controlled atomization and projection of pattern of droplets with modification of air flow. More particularly, the present invention augments the use of airflow modifying 1. vortex spray pattern, and 2. spray cone shape projection pattern for improvement of spray coverage for many applications. In agriculture and horticulture spraying, spray droplets, besides being sprayed onto the plants' foliage surface facing the sprayer must also travel around the blocking foliage and spray the leaves behind. A good vortex spray projection pattern is essential for this purpose. While the sprayer turbine fan blades produce a much looser or large diameter vortex, curved supports for the spinner and turbine motors FIGS. 1, 2, 4, 5, 6, and 7 modify the loose airflow spiral to a much tighter one progressively from 15 to 6 to 6a to 6b to 6c to 6d. Airflow and spray droplets exiting the sprayer generated from the spinner result in a much tighter spiral. Primary cone can be adjusted forward or backward FIGS. 4, 5, 6, and 7 to regulate spray droplet cone size and shape. An optional secondary cone FIGS. 1, 2, 4, 5, 6, and 7 allows exit air of sprayer to generate a narrow cone by Venturi effect augmenting the tight spiral and helping reduce the sparse droplet zone FIGS. 4 & 5, 10. This Venturi effect generated airflow assists the main airflow to redirect the traveling direction and path of spray droplets that were tangentially projected in a disk shape from the outer circular edge of the turning spinner and integrated with the airflow now in a vortex pattern. The single taper shaped spinning droplet generator modified from U.S. Pat. No. 6,152,382 as in FIG. 3 to FIGS. 1, & 2; 8 helps to shape air flow to reduce the sparse droplets areas.

What is claim is:

1. An apparatus as modified sprayer in U.S. Pat. No. 6,152,382 for multiple uses in spraying of fluid onto a surface comprising:
means to penetrate blocking foliage on target in agricultural and horticultural spraying, more uniform droplet distribution, uniform coating by droplets on sprayed surfaces, production of a cone pattern of projected spray and control of sizes of spray cone reducing the drift of droplets by eliminating the spare spray droplets at the fringe of spray pattern
including
spinning cone with added opposite shaped taper
employing an adjustable primary cone means to tighten spray and air spiral, and determine shape of spray cone pattern
employing an optional secondary cone means for generating additional airflow by Venturi effect for tightening of spray and airflow spiral,
minimizing sparse spray zone size
curved support of motor components means to initially tighten spiral air pattern of incoming air produced by the air turbine fan

2. An apparatus as in claim 1 including means for producing a tighter airflow spiral by using curved supports between motor support and sprayer housing in the passage of airstream.

3. An apparatus as in claim 1 including means for further tightening of air flow pattern and allowing adjustment of spray cone shape by means of an adjustable cone component.

4. An apparatus as in claim 1 that includes a secondary cone component to obtain additional airflow with pattern reduce spray zone size and further tighten the shape of spray and air vortex exiting sprayer.
